(19) United States
(12) Patent Application Publication
(10) Pub. No.: US 2011/0030568 A1
(43) Pub. Date: Feb. 10, 2011

(54) PRESS-FITTING DIE

(75) Inventor: Lai Chu Tsai, Yilan County (TW)

Correspondence Address: LAW OFFICES OF MIKIO ISHIMARU, 333 W. EL CAMINO REAL, SUITE 330, SUNNYVALE, CA, 94087, US

(73) Assignee: Lai Chu Tsai, Yilan County (TW)

(21) Appl. No.: 12/563,687

(22) Filed: Sep. 21, 2009

(30) Foreign Application Priority Data
Aug. 6, 2009 (TW) 098214530

(51) Int. Cl. B44B 5/02

(52) U.S. Cl. 101/28

(57) ABSTRACT

Provided is a press-fitting die including two removable templates each having two opposing surfaces (front and back) with molds provided thereon, respectively. A first pattern is impressed with the templates pivoted into contact with each other under user-applied pressure in a front-to-front manner with respect to the templates. Likewise, after turning each of the removable templates over, a second pattern is impressed with the templates pivoted into contact with each other under user-applied pressure in a back-to-back manner with respect to the templates. Hence, two different patterns are impressed using a single press-fitting die, thereby reducing the number of press-fitting dies required to emboss a number of patterns, thus reducing costs incurred in impressing patterns.

### BACKGROUND OF THE INVENTION

1. Field of the Invention

The present invention relates to press-fitting dies, and, more particularly, to a press-fitting die capable of reducing costs of creating patterns.

2. Description of the Prior Art

Press-fitting dies used in making handicrafts are configured to impress specific patterns or letters on a thin material, such as paper, film, foam, foil, soft magnetic sheets, photos, leather, fabric, and so on, or to impress embossed patterns or letters on thin finished products, such as a cards, a photo albums, or packages.

In general, templates for use with press-fitting die are fabricated and operated by the steps of: injecting plastics so as to form two plastic templates (complementary in height) with patterns corresponding in shape to each other; affixing the two plastic templates to two hinged and yet foldable plastic boards, respectively; and folding the plastic boards under user-applied pressure so as to impress patterns on the material being embossed.

Referring to FIGS. 1A and 1B, which are top and cross-sectional views, respectively, of a conventional press-fitting die, the press-fitting die comprises: a first frame 10a having a first recess 100a, a second frame 10b having a second recess 100b, a first template 11a, and a second template 11b. The bottom side 101a of the first recess 100a functions as a first press-fitting surface. Likewise, the bottom side 101b of the second recess 100b functions as a second press-fitting surface. The first template 11a is affixed to the first press-fitting surface 101a, and the first template 11a has a first patterned mold 110a provided thereon. Similarly, the second template 11b is affixed to the second press-fitting surface 101b, and the second template 11b has a second patterned mold 110b provided thereon.

To operate the conventional press-fitting die, a user has to put a piece of material between the first template 11a and the second template 11b and press the first frame 10a and the second frame 10b against each other so as for the first patterned mold 110a and the second patterned mold 110b to be pressed against the piece of material therebetween concurrently in order to emboss patterns on the piece of material.

With the first and second templates 11a, 11b being affixed to the first and second press-fitting surfaces 101a, 101b, respectively, it is not readily possible to separate the templates from the frames. As a result, the conventional press-fitting die can impress only one type of embossed pattern on a piece of material. From a user's perspective, additional patterns may not be embossed without using an additional press-fitting die. Hence, if the user desires to impress a number of patterns, the user will need the same number of press-fitting dies as the number of desired patterns. For example, if the user wants to impress 10 different patterns, the user will need 10 different press-fitting dies, which incurs considerable costs and therefore is less feasible from a commercial point of view.

Accordingly, it would be highly desirable to provide a press-fitting die for reducing the costs of impressing patterns so as to overcome the aforesaid drawback of the prior art.

### SUMMARY OF THE INVENTION

In view of the aforesaid drawback of the prior art, it is a primary objective of the present invention to provide a press-fitting die that is capable of reducing the number of press-fitting die assemblies required for embossing multiple patterns, thus reducing the costs of creating patterns.

The present invention provides a press-fitting die, comprising: a first template having two opposing surfaces with first and second molds provided thereon, respectively; and a second template separably coupled to the first template and having two opposing surfaces with third and fourth molds provided thereon, respectively, the third mold being configured to be pressed against the first mold and the fourth mold being configured to be pressed against the second mold.

The first template and the second template are coupled together in a hinged manner so as for the first template and the second template to pivot towards each other.

The templates of the press-fitting die are plastic boards or metallic boards. In other embodiments, the templates can be made of any materials as appropriate.

The press-fitting die further comprises a first frame with a first press-fitting surface and a second frame with a second press-fitting surface. The first template is removably disposed on the first press-fitting surface of the first frame. Likewise, the second template is removably disposed on the second press-fitting surface of the second frame.

The first press-fitting surface and the second press-fitting surface are configured to face each other. The first frame and the second frame are coupled together by means of a hinge so as for the first and second frames to pivot towards each other.

The templates are disposed on the press-fitting surfaces of the frames, respectively. The frames each have a recess. The bottom sides of the recesses are defined by the press-fitting surfaces, respectively.

In addition to the basic function of being removable, the press-fitting die further comprises a suction portion whereby the templates are attached to the press-fitting surfaces by suction, respectively, or an engagement portion whereby the templates engage with the press-fitting surfaces, respectively.

As indicated above, the present invention provides removable templates whereby a user impresses two different embossed patterns using one and only one press-fitting die. Unlike the prior art that discloses “one pattern, one press-fitting die,” the present invention discloses “two patterns, but only one press-fitting die,” thus effectively reducing the amount of equipment involved and costs incurred in impressing patterns.

### BRIEF DESCRIPTION OF THE DRAWINGS

FIG. 1A is a top view of a conventional press-fitting die;

FIG. 1B is a cross-sectional view of the conventional press-fitting die prior to pressing;

FIG. 2A is a top view of a first embodiment of a press-fitting die according to the present invention;

FIG. 2B is a cross-sectional, exploded view of the first embodiment of the press-fitting die prior to pressing according to the present invention;

FIG. 3A is a top view of a second embodiment of the press-fitting die according to the present invention;

FIG. 3B is a cross-sectional view of the second embodiment of the press-fitting die prior to pressing according to the present invention; and

FIG. 4 is a perspective view of a third embodiment of the press-fitting die according to the present invention.

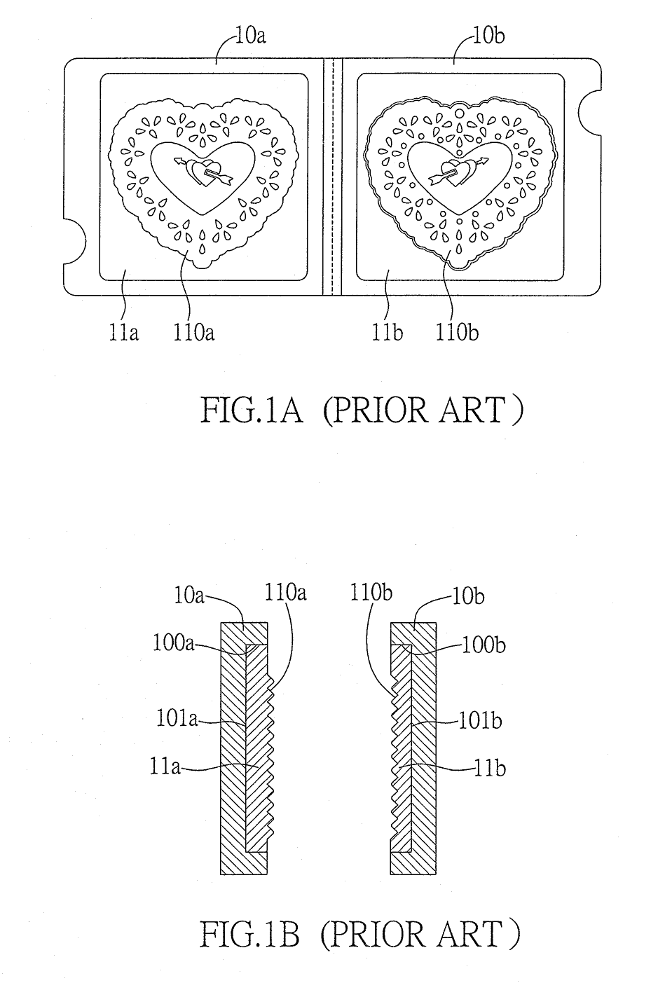

### DETAILED DESCRIPTION OF THE EMBODIMENTS

The following descriptions of specific embodiments are provided to illustrate and disclose ways of implementing the present invention and are not intended to be restrictive of the scope of the present invention. Persons skilled in the art can readily understand the advantages and functions of the present invention by reference to the disclosure contained in the specification.

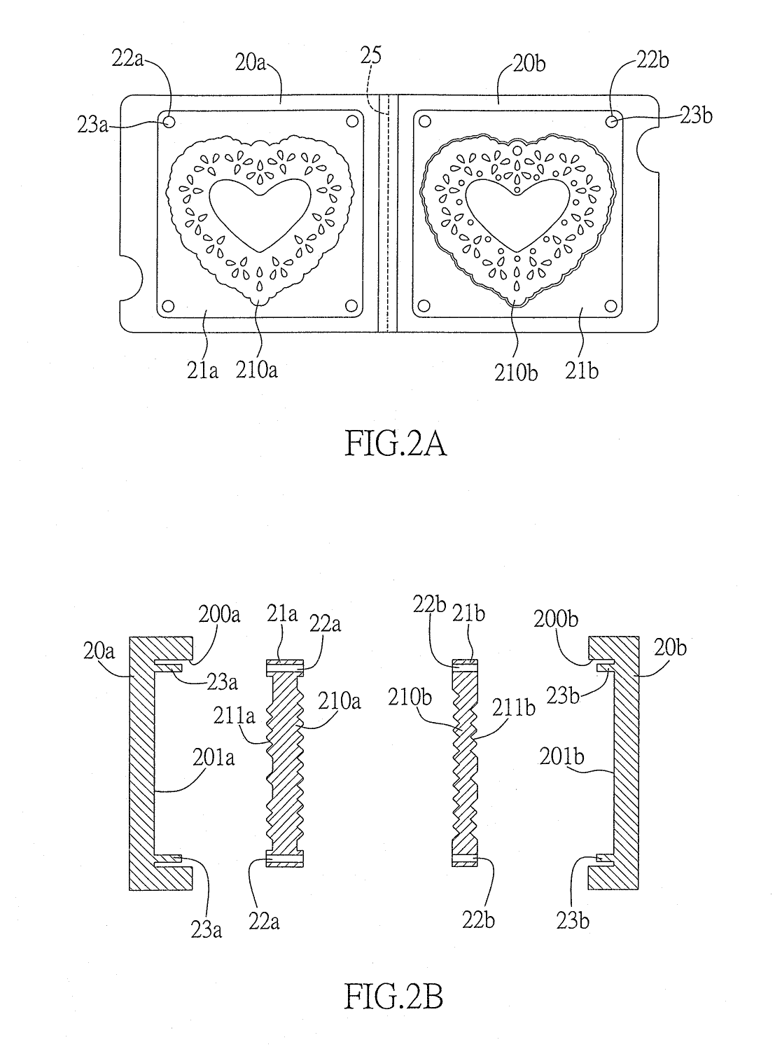

Referring to FIGS. 2A and 2B, which are top and cross-sectional views, respectively, of a first embodiment of a press-fitting die according to the present invention, the press-fitting die comprises a first frame 20a, a second frame 20b, a first template 21a, and a second template 21b.

The first frame 20a has a first recess 200a, and the bottom side of the first recess 200a functions as a first press-fitting surface 201a. Likewise, the second frame 20b has a second recess 200b, and the bottom side of the second recess 200b functions as a second press-fitting surface 201b.

The second press-fitting surface 201b corresponds in position to the first press-fitting surface 201a so as for a user to align the first press-fitting surface 201a with the second press-fitting surface 201b. Preferably, the second frame 20b is coupled to the first frame 20a by means of a pivotal structure 25, such as a hinge, to allow the first frame 20a and the second frame 20b to separably pivot towards each other and thereby allow the first press-fitting surface 201a and the second press-fitting surface 201b to come into contact with each other under user-applied pressure. The pivotal structure 25 comes in different forms, the exact form not being an essential technical feature of the present invention; hence, the pivotal structure 25 is not described in detail herein.

The first template 21a is removably positioned on the first press-fitting surface 201a of the first frame 20a. The two opposite surfaces of the first template 21a have first and second molds 210a, 211a provided thereon, respectively. The first template 21a is a plastic board, or it is a metallic board preferably made of stainless steel. However, in other embodiments, the first template 21a can be made of other materials.

The second template 21b is removably positioned on the second press-fitting surface 201b of the second frame 20b. The two opposite surfaces of the second template 21b have third and fourth molds 210b, 211b provided thereon, respectively. The third mold 210b is pressed against the first mold 210a so as for a first embossed pattern to be formed. The fourth mold 211b is pressed against the second mold 211a so as for a second embossed pattern to be formed. The second template 21b is a plastic board, or it is a metallic board preferably made of stainless steel. However, in other embodiments, the second template 21b can be made of other materials.

Where the templates are selectively made of plastics, patterns on the molds are fabricated by injection molding. Injection molding technology is well-documented and therefore is not described herein. Where the templates are selectively made of a metal, patterns on the molds are fabricated by etching. Etching technology is also well-documented, and thus only one type of etching is concisely described herein, with no intention of limiting the scope of the present invention thereto.

First, a metallic substrate is coated with printing ink so as for the printing ink thus coated to function as a corrosion-resistant photoresist layer. Then, a negative that bears patterns or letters is processed by exposure and development to allow a patterned etching area to be defined on the corrosion-resistant photoresist layer and a portion of the metallic substrate to be exposed from the patterned etching area. Afterward, the patterned etching area is etched so as for the exposed portion of the metallic substrate to be removed by etching to thereby finalize the pattern formed on the mold, wherein the pattern thus finalized is defined by the unexposed portion of the metallic substrate. Lastly, the corrosion-resistant photoresist layer is removed from the metallic substrate so as to finalize fabrication of the template.

In the first embodiment, the press-fitting die further comprises an engagement portion. The engagement portion further comprises one or more engaging holes 22a provided in the first template 21a and one or more posts 23a provided on the first press-fitting surface 201a and corresponding in position to the engaging holes 22a. With each post 23a being inserted into a corresponding engaging hole 22a, the first template 21a is engaged with and fixed in position on the first press-fitting surface 201a. Both the one or more engaging holes 22a and the one or more corresponding posts 23a serve a positioning function instead of a permanent coupling function, and thus the first template 21a is fixed in position, rather than permanently coupled, to the first press-fitting surface 201a and yet is removable therefrom.

Likewise, one or more engaging holes 22b are provided in the second template 21b, and one or more corresponding posts 23b are provided on the second press-fitting surface 201b. With the one or more posts 23b being inserted into the one or more engaging holes 22b, the second template 21b is engaged with and fixed in position to the second press-fitting surface 201b and yet is removable therefrom.

As such, the templates are selectively engaged with the frames, respectively, by inserting the posts 23a, 23b into the engaging holes 22a, 22b. The templates can be made of any material as appropriate, though preferably a plastic. The frames are selectively made of the same material as the templates.

To impress a first embossed pattern using a press-fitting die of the present invention (as shown in FIG. 2A), the user has to: position the first template 21a on the first frame 20a with the first mold 210a facing outward; position the second template 21b on the second frame 20b with the third mold 210b facing outward; pivot the first and second frames 20a, 20b toward each other; dispose a pre-pressing object, such as a piece of paper, between the first template 21a and the second template 21b; align the first mold 210a with the third mold 210b; and press first and second frames 20a, 20b against the piece of paper sandwiched therebetween so as to impress the first embossed pattern on the piece of paper.

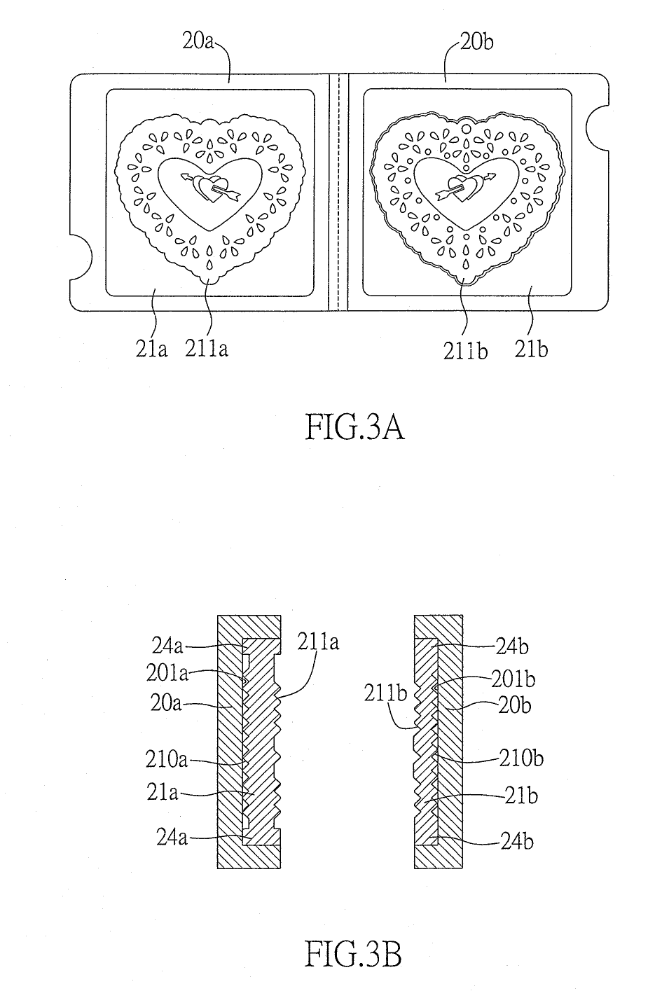

Similarly, to impress a second embossed pattern (as shown in FIG. 3A), the user has to: remove the first and second templates 21a, 21b from the first and second frames 20a, 20b, respectively; turn over and position the first template 21a on the first frame 20a with the second mold 211a facing outward; turn over and position the second template 21b on the second frame 20b with the fourth mold 211b facing outward; pivot the first and second frames 20a, 20b toward each other; dispose a pre-pressing object, such as a piece of paper, between the first template 21a and the second template 21b; align the second mold 211a with the fourth mold 211b; and press first and second frames 20a, 20b against the piece of paper sandwiched therebetween so as to impress the second embossed pattern on the piece of paper.

The present invention provides removable templates whereby a user impresses two different embossed patterns using a single press-fitting die. Unlike the prior art that teaches “one pattern, one press-fitting die,” the present invention demonstrates high industrial applicability and is effective in cutting costs incurred in impressing patterns. For example, to impress 10 different patterns, a user needs 10 different press-fitting dies according to the prior art, but only five according to the present invention. Potentially, the present invention reduces the equipment involved and costs incurred in impressing patterns by up to half as otherwise required.

The present invention has high industrial applicability, because the present invention basically matches the prior art in durability and cost of materials and yet impresses two different patterns, that is, one more pattern than the prior art does. To do so, the present invention discloses forming two molds on two opposing surfaces of each of the templates, respectively, that is, one more mold than the prior art does, by performing a patterning process on the two opposing surfaces of the template, whether the patterning process involves performing injection molding or etching.

Referring to FIGS. 3A and 3B, top and cross-sectional views, respectively, are shown of a second embodiment of the press-fitting die according to the present invention. The second embodiment differs from the first embodiment in the way of positioning the templates on the frames. The difference is described below.

The press-fitting die further comprises an attraction portion, such as a suction cup or a magnet, capable of attracting and configured to attach the templates to the press-fitting surfaces, respectively, by attractive force. In the second embodiment, the attraction portion is preferably a magnet.

A periphery 24a of the first template 21a is attached to the first press-fitting surface 201a by suction or magnetic attraction. A periphery 24b of the second template 21b is likewise attached to the second press-fitting surface 201b by suction or magnetic attraction. The templates can be made of any material as appropriate, though preferably metal. The frames are made of a magnetic material. Alternatively, magnets of positive and negative poles are positioned on the peripheries 24a, 24b of the first and second templates 21a, 21b and the first and second frames 20a, 20b, respectively, so as for the first and second templates 21a, 21b to be attracted to the first and second frames 20a, 20b, respectively. In the second embodiment, the second and fourth molds 211a, 211b face outward.

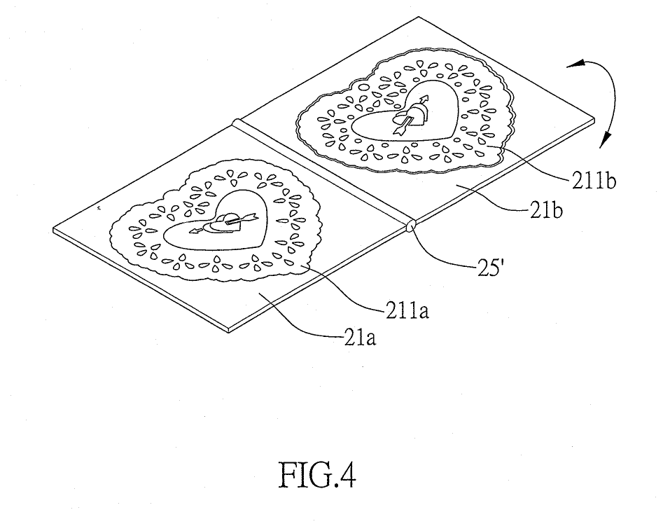

Referring to FIG. 4, a perspective view is shown of a third embodiment of the press-fitting die according to the present invention. The third embodiment differs from the second embodiment in that, in the third embodiment, no frame is required.

Referring to FIG. 4, the first template 21a and the second template 21b are separably coupled together. Preferably, the first template 21a and the second template 21b are coupled together in a bidirectional pivotal manner by means of a pivoting structure 25′ to thereby allow the first and second templates 21a, 21b to pivot toward each other in a front-to-front manner (that is, with the first and third molds 210a, 210b facing each other (not visible in the drawing)) and in a back-to-back manner (that is, with the second and fourth molds 211a, 211b facing each other). The pivoting structure 25′ is a hinge configured for bidirectional rotation. Elements configured for bidirectional rotation come in different forms, and in that the form is not an essential technical feature of the present invention, the pivoting structure 25′ is not described herein.

To impress the first embossed pattern using the press-fitting die of the present invention, the user has to: pivot the first and second templates 21a, 21b toward each other in a front-to-front manner (that is, with the first mold 210a and the third mold 210b facing each other); dispose a pre-pressing object, such as a piece of paper, between the first mold 210a with the third mold 210b; align the first mold 210a with the third mold 210b; and press first and second templates 21a, 21b against the piece of paper sandwiched therebetween so as to impress the first embossed pattern on the piece of paper.

To impress the second embossed pattern, the user has to: pivot the first and second templates 21a, 21b toward each other in a back-to-back manner (that is, with the second mold 211a and the fourth mold 211b facing each other); dispose a pre-pressing object, such as a piece of paper, between the second mold 211a with the fourth mold 211b; align the second mold 211a with the fourth mold 211b; and press first and second templates 21a, 21b against the piece of paper sandwiched therebetween so as to impress the second embossed pattern on the piece of paper.

In conclusion, a press-fitting die of the present invention is provided with removable templates whereby a user impresses two different embossed patterns using one and only one press-fitting die to thereby cut costs incurred in impressing patterns and promote industrial applicability of the press-fitting die, as the present invention entails performing the same process as the prior art does and yet the press-fitting die of the present invention impresses one more pattern than a conventional press-fitting die does. Also, the templates of the press-fitting die of the present invention are applicable to pattern printing.

The foregoing descriptions of the detailed embodiments are provided to illustrate and disclose the features and functions of the present invention and are not intended to be restrictive of the scope of the present invention. As such, it should be understood by those in the art that many modifications and variations can be made according to the spirit and principles in the disclosure of the present invention and still fall within the scope of the invention as set forth in the appended claims.

What is claimed is:

1. A press-fitting die, comprising:
a first template having two opposing surfaces with first and second molds provided thereon, respectively; and
a second template separably coupled to the first template and having two opposing surfaces with third and fourth molds provided thereon, respectively, so as for the third mold to be pressable against the first mold and the fourth mold to be pressable against the second mold.

2. The press-fitting die of claim 1, further comprising a first frame for removably receiving the first template.

3. The press-fitting die of claim 2, further comprising a second frame for removably receiving the second template, wherein the first frame and the second frame are coupled together by means of hinging and thus are pivotal towards each other.

4. The press-fitting die of claim 2, wherein the first frame has a first press-fitting surface in contact with the first template.

5. The press-fitting die of claim 4, wherein the first frame further has a first recess with a bottom side thereof functioning as the first press-fitting surface.

6. The press-fitting die of claim 2, further comprising an attraction portion whereby the first template is attached to the first frame by an attractive force.

7. The press-fitting die of claim 2, further comprising an engagement portion whereby the first template engages with the first frame.

8. The press-fitting die of claim 1, further comprising a second frame for removably receiving the second template.

9. The press-fitting die of claim 8, wherein the second frame has a second press-fitting surface in contact with the second template.

10. The press-fitting die of claim 9, wherein the second frame further has a second recess with a bottom side thereof functioning as the second press-fitting surface.

11. The press-fitting die of claim 8, further comprising an attraction portion whereby the second template is attached to the second frame by an attractive force.

12. The press-fitting die of claim 8, further comprising an engagement portion whereby the second template engages with the second frame.

13. The press-fitting die of claim 1, wherein the first template and the second template are coupled together in a bidirectional pivotal manner to thereby allow the first and second templates to pivot towards each other in at least one of a front-to-front manner and a back-to-back manner.

14. The press-fitting die of claim 1, wherein the first template is a plastic board.

15. The press-fitting die of claim 1, wherein the second template is a plastic board.

16. The press-fitting die of claim 1, wherein the first template is a metallic board.

17. The press-fitting die of claim 1, wherein the second template is a metallic board.
